(19) United States
(12) Patent Application Publication
(10) Pub. No.: US 2023/0038078 A1
(43) Pub. Date: Feb. 9, 2023

(54) INDICATING FAILED CARD READING TO IDENTIFY DEFECTIVE TRANSACTION CARD AND/OR DEFECTIVE TRANSACTION TERMINAL

(71) Applicant: Capital One Services, LLC, McLean, VA (US)

(72) Inventors: Abdelkader M'Hamed BENKREIRA, Brooklyn, NY (US); Michael MOSSOBA, Great Falls, VA (US); Joshua EDWARDS, Philadelphia, PA (US)

(21) Appl. No.: 17/444,684

(22) Filed: Aug. 9, 2021

(51) Int. Cl. G06K 7/00; G06K 19/07; G07F 7/08

(52) U.S. Cl. CPC G06K 7/0095; G06K 7/0008; G06K 19/0722; G07F 7/0873

(57) ABSTRACT

In some implementations, a point of sale (POS) system may store a card read failure indication based on detecting that a transaction terminal failed to read information associated with a transaction card, wherein the card read failure indication includes information that indicates whether the transaction terminal failed to read the information associated with the transaction card from a chip, a magnetic stripe, or a contactless device. The POS system may transmit information associated with the card read failure indication to an external device based on detecting a successful transaction subsequent to the transaction terminal failing to read the information associated with the transaction card, wherein the information associated with the card read failure indication is transmitted to enable the external device to determine whether one or more of the transaction card or the transaction terminal is defective.

### BACKGROUND

A transaction terminal, sometimes referred to as a payment terminal or a point of sale (POS) terminal, is a device that interfaces with a transaction card to enable an electronic funds transfer. For example, a transaction terminal typically includes a screen, a secure keypad to enter a personal identification number or other inputs, one or more mechanisms to capture information from a transaction card, and a network connection to access a payment network for authorization. The transaction terminal may allow a merchant to capture information from a transaction card (e.g., a credit card or debit card) and to transmit the captured information to a merchant services provider or bank to request authorization and to transfer funds to the merchant. For example, the transaction terminal may allow a customer or the merchant to insert the transaction card into the transaction terminal to read information from a chip associated with the transaction card, swipe the transaction card through a magnetic card reader to read information from a magnetic stripe associated with the transaction card, and/or hold the transaction card near the transaction terminal to read information from the card using near field communication (NFC).

### SUMMARY

Some implementations described herein relate to a system for indicating failed card readings to identify defective transaction cards or defective transaction terminals. The system may include one or more memories and one or more processors coupled to the one or more memories. The one or more processors may be configured to store a card read failure indication based on a transaction terminal failing to read information associated with a transaction card from a chip, a magnetic stripe, or a contactless device associated with the transaction card. The one or more processors may be configured to detect a successful transaction using the transaction card based on one or more inputs manually entering the information associated with the transaction card at the transaction terminal. The one or more processors may be configured to transmit, to an external device, information associated with the card read failure indication based on the one or more inputs manually entering the information associated with the transaction card.

Some implementations described herein relate to a method for detecting and indicating failed card readings. The method may include detecting, by a point-of-sale (POS) system, that a transaction terminal failed to read information associated with a transaction card. The method may include storing, by the POS system, a card read failure indication based on the transaction terminal failing to read the information associated with the transaction card, where the card read failure indication includes information that indicates whether the transaction terminal failed to read the information associated with the transaction card from a chip, a magnetic stripe, or a contactless device. The method may include transmitting, by the POS system, information associated with the card read failure indication to an external device based on detecting a successful transaction subsequent to the transaction terminal failing to read the information associated with the transaction card, where the information associated with the card read failure indication is transmitted to enable the external device to determine whether one or more of the transaction card or the transaction terminal is defective.

Some implementations described herein relate to a non-transitory computer-readable medium that stores a set of instructions for a system. The set of instructions, when executed by one or more processors of the system, may cause the system to store a card read failure indication based on a transaction terminal failing to read information associated with a transaction card. The set of instructions, when executed by one or more processors of the system, may cause the system to detect a successful transaction using the transaction card. The set of instructions, when executed by one or more processors of the system, may cause the system to transmit, to an external device, information associated with the card read failure indication based on the successful transaction using the transaction card.

### BRIEF DESCRIPTION OF THE DRAWINGS

FIG. 1 is a diagram of an example implementation relating to indicating a failed card reading to identify a defective transaction card and/or a defective transaction terminal.

FIG. 2 is a diagram of an example environment in which systems and/or methods described herein may be implemented.

FIG. 3 is a diagram of example components of one or more devices of FIG. 2.

FIG. 4 is a flowchart of an example process relating to indicating a failed card reading to identify a defective transaction card and/or a defective transaction terminal.

### DETAILED DESCRIPTION

The following detailed description of example implementations refers to the accompanying drawings. The same reference numbers in different drawings may identify the same or similar elements.

As described above, a transaction terminal typically includes, among other things, one or more mechanisms to capture information from a transaction card (e.g., a credit card or debit card) such that the captured information may be transmitted to a transaction backend system to request that funds be transferred to a merchant operating the transaction terminal. For example, the transaction terminal may include a chip reader that can read information from a chip (e.g., an integrated circuit) on the transaction card when the transaction card is inserted into the chip reader, a magnetic card reader that can read information from a magnetic stripe when the transaction card is swiped through the magnetic card reader, and/or a contactless device (e.g., a near field communication (NFC) or radio frequency (RF) reader) that can read information from the transaction card when the transaction card is tapped against or held in close proximity to the contactless device. However, in some cases, the transaction terminal may fail to correctly read information from the transaction card. For example, a transaction terminal with a chip reader may fail to read information from the chip on the transaction card, which may be caused by a defective transaction terminal (e.g., due to damage to a sled that includes one or more torsion springs that guide and press a transaction card with a chip into a contact reader), a defective transaction card (e.g., damage to the chip itself), and/or improper usage (e.g., an upside-down or backward insertion, a bad insertion angle, and/or an incomplete insertion). In other examples, the transaction terminal may fail to read information from the magnetic stripe because the magnetic card reader is defective and/or because the magnetic stripe is worn down due to wear-and-tear, and/or may fail to read information from a contactless device because the contactless device of the transaction terminal or the transaction card is defective and/or because the transaction card was tapped against the transaction terminal at the wrong location.

Accordingly, in various circumstances, one or more mechanisms that a transaction terminal supports to read information from a transaction card may fail to correctly read the transaction card, which may result in a fallback transaction (e.g., where the magnetic stripe is swiped through the magnetic card reader after a failure to read the chip). However, resorting to a fallback transaction increases the risk of credit card fraud, as chip card transactions use cryptographic algorithms and other techniques that offer improved security against fraud relative to fallback (e.g., magnetic stripe) transactions that rely on the cardholder's signature and visual inspection of the transaction card to check for features such as holograms. Furthermore, in cases multiple mechanisms fail to correctly read the information from the transaction card, the merchant may need to resort to manually entering the credit card information into the transaction terminal, which is processed similarly to a card-not-present transaction that poses a significant fraud risk. However, when an attempt to read information from a transaction card fails, no information is transferred to the transaction terminal about the transaction card and/or an issuer of the transaction card, so there is no opportunity to report the card read failure to the issuer of the transaction card and/or to another merchant device that can then determine whether the card read failure is attributable to a defective payment terminal, a defective transaction card, or an anomalous event (e.g., an incorrect insertion, an incorrect swipe, or tap at the wrong location). As a result, the issuer of the transaction card and/or the merchant operating the transaction terminal may be unable to identify defective card reading equipment and/or a defective transaction card, which may result in an increased fraud risk (e.g., due to more fallback transactions or manual entry transactions) if the defective card reading equipment and/or defective transaction card continue to be used.

Some implementations described herein relate to techniques to generate a card read failure indication when a transaction terminal fails to read information from a transaction card, and to transmit the card read failure indication to an external device that may be configured to proactively determine whether the transaction terminal or the transaction card is defective based on the card read failure indication. For example, in some implementations, the transaction terminal may detect a card read failure in cases where a transaction card with a chip is inserted into the transaction terminal, but the transaction terminal is unable to read any data from the transaction card and/or the chip. In another example, the transaction terminal may detect a card read failure indication based on a magnetic card reader obtaining incomplete information or information that cannot be correctly interpreted. In cases where the transaction terminal detects a card read failure, the transaction terminal may store (e.g., in a cache) a card read failure indication that includes information related to the failed attempt to read the transaction card. For example, the card read failure indication may include a date, a time, or a timestamp, a read type (e.g., chip, magnetic stripe, contactless device), partial or incomplete information that was read from the transaction card, a number of failures within a time period or a time between failures, and/or an error code that may include information to aid with diagnosing or troubleshooting an issue that caused the card read failure.

Accordingly, when a successful transaction occurs following a card read failure (e.g., based on manual entry of the transaction card information, a successful fallback transaction in which the transaction card is swiped after a failed chip read, and/or a consumer using a different transaction card that is successfully read), the transaction terminal may transmit the card read failure indication to the external device that can determine whether the transaction terminal or the transaction card is defective. For example, the external device may be a merchant device at a point of sale (POS) system that includes the transaction terminal, in which case the merchant device may determine that the transaction terminal is defective based on the transaction terminal reporting a quantity or proportion of card read failures that satisfies a threshold. In another example, the external device may be associated with the issuer of the transaction card, which may have a capability to determine whether the transaction card is defective (e.g., based on card read failure indications reported by multiple transaction terminals) in addition to a capability to identify defective transaction terminals. In this way, defective card reading equipment and/or defective transaction cards may be proactively replaced, which may reduce a fraud risk by reducing a number of fallback transactions and/or manual entry transactions that may be caused by defective card reading equipment and/or defective transaction cards.

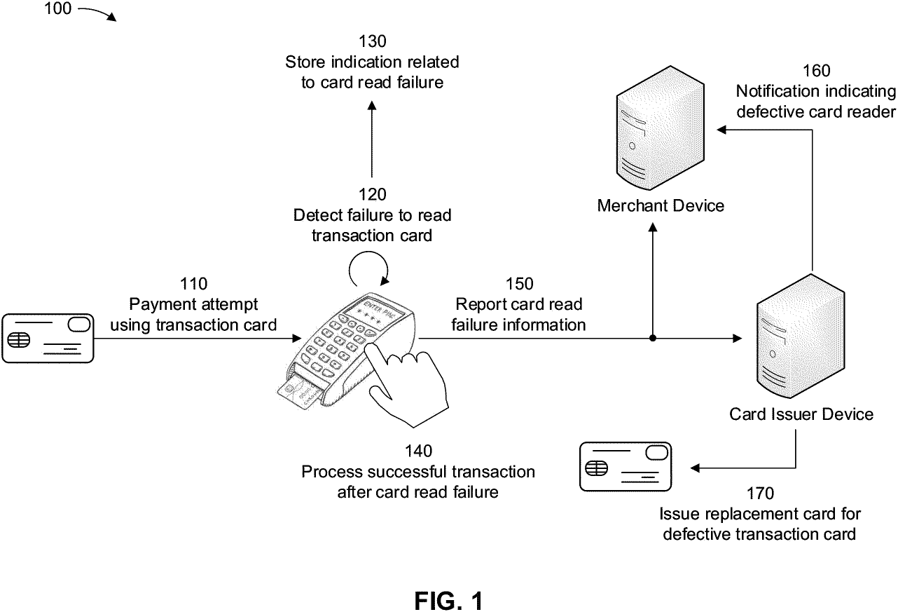

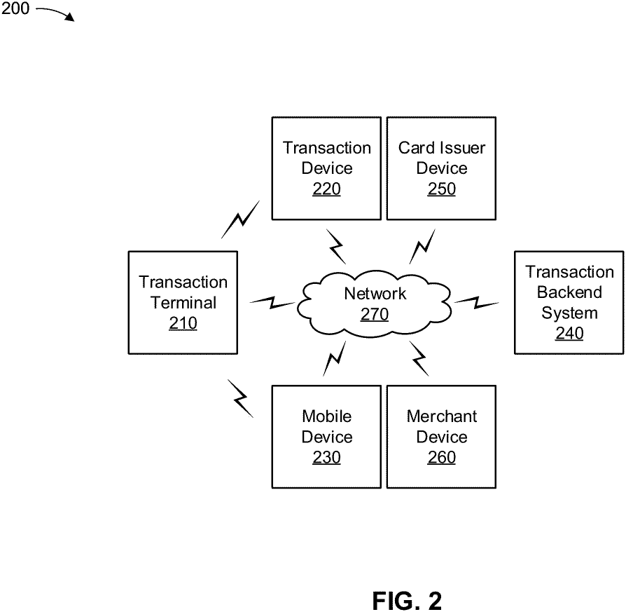

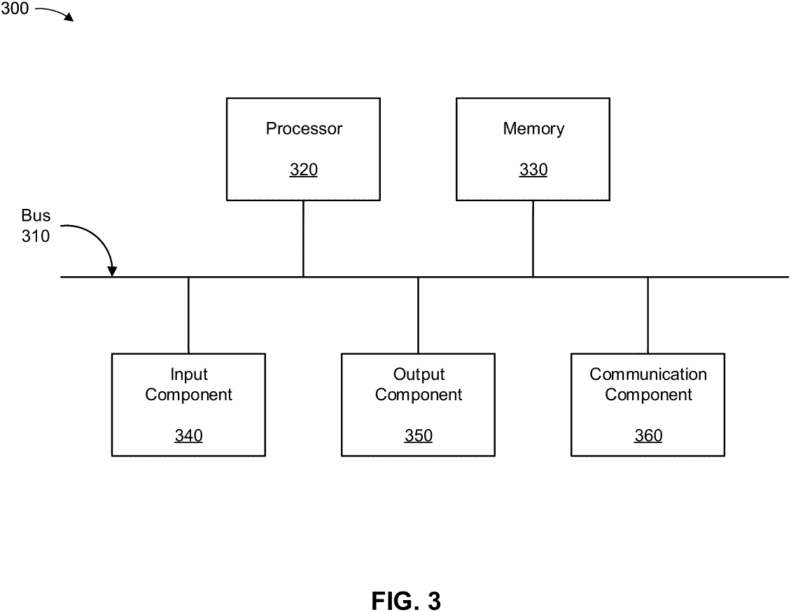

FIG. 1 is a diagram of an example 100 associated with indicating a failed card reading to identify a defective transaction card and/or a defective transaction terminal. As shown in FIG. 1, example 100 includes a transaction card (e.g., a transaction device), a transaction terminal, a merchant device, and a card issuer device. In some implementations, the transaction terminal and the merchant device may be connected or included in a point of sale (POS) system such that payment amounts and payment confirmations can be automatically transferred to the POS system. Additionally, or alternatively, the transaction terminal may be operated in a standalone mode, where a merchant keys an amount into the transaction terminal before the customer presents the transaction card to complete a transaction. Furthermore, in some implementations, the card issuer device may be connected to or otherwise associated with a transaction backend system (not shown) that may communicate with the transaction terminal and/or the merchant device to process one or more transactions using transaction cards. The transaction card, the transaction terminal, the merchant device, the card issuer device, and the transaction backend system are described in more detail below in connection with FIG. 2 and FIG. 3.

As shown in FIG. 1, and by reference number 110, a payment using the transaction card may be attempted at the transaction terminal. For example, in some implementations, the payment attempt may include inserting the transaction card into the transaction terminal, which may include a chip reader configured to attempt to read information from a chip on the transaction card. In another example, the payment attempt may include swiping the transaction at the transaction terminal, which may include a magnetic card reader configured to attempt to read information from a magnetic stripe on the transaction card. In another example, the payment attempt may include tapping the transaction card against the transaction terminal or holding the transaction card in proximity of the transaction terminal, which may include a contactless device (e.g., an RF reader or NFC device) configured to attempt to read information from a contactless device on the transaction card. In some implementations, in cases where the transaction card and the card reading equipment of the transaction terminal are functioning correctly (e.g., the chip reader is able to read the chip, the magnetic card reader is able to read the magnetic stripe, and/or the contactless devices of the transaction card and the transaction terminal are able to exchange information), the transaction terminal may communicate with the transaction backend system (not shown) to process the payment. However, in various circumstances, the transaction terminal may be unable to correctly read information from the transaction card. In such cases, as described herein, the transaction terminal may store a card read failure indication and/or report the card read failure indication to an external device that may determine whether the transaction terminal and/or the transaction card is defective.

For example, as further shown in FIG. 1, and by reference number 120, the transaction terminal may detect a failure to read the transaction card. In general, as described herein, the transaction terminal may detect the failure to read the transaction card based on a failure to detect or read a chip associated with the transaction card, a partial read, an incomplete read, or a failure to read the magnetic stripe, and/or or a threshold quantity of tap attempts in which the transaction terminal reads partial, incomplete, or no information from the contactless device associated with the transaction card. For example, in cases where the transaction card is inserted into the transaction terminal, the chip reader of the transaction terminal may detect the transaction card and/or the chip of the transaction card but may be unable to read data from the chip due to the chip or the chip reader having wear-and-tear, damage, or other defects. Alternatively, in some cases, the chip reader may be unable to read the information from the chip because the transaction card was inserted incorrectly (e.g., upside-down or backwards), inserted incompletely, or inserted at a bad angle such that one or more torsion springs are unable to correctly guide and press the transaction card into a contact reader. In other words, the card read failure may be caused by a defective transaction card, a defective transaction terminal, or another condition that is unrelated to the transaction card or the transaction terminal having any defects. In a similar respect, the transaction terminal may detect a failure to read the transaction card after a swipe using the magnetic card reader. In such cases, the card read failure may be caused by damage to the magnetic stripe on the transaction card (e.g., a demagnetized or worn magnetic stripe), faulty card reading equipment (e.g., due to dirty or damaged read heads), and/or improper usage (e.g., failing to hold the transaction card in the magnetic card reader or reversing the orientation of the transaction card such that the magnetic stripe does not interface with the magnetic card reader). Additionally, or alternatively, the transaction may detect the failure to read the transaction card after an attempted contactless transaction (e.g., the transaction terminal may be able to detect the presence of the transaction card but cannot read information from the transaction card or may be able to read information that cannot be interpreted to complete the payment attempt). In some implementations, the card read failure may be detected after the contactless transaction is attempted and fails a threshold quantity of times (e.g., to account for consumers often inadvertently tapping the wrong location on the transaction terminal). In another example, the transaction terminal may include one or more cameras or sensors (e.g., biometric sensors, such as a fingerprint reader or palm scanner) that may fail to correctly read a transaction card or information linked to the transaction card.

As further shown in FIG. 1, and by reference number 130, the transaction terminal may store an indication related to the card read failure (e.g., in a cache or other suitable memory). For example, in some implementations, the card read failure indication may include information related to when the card read failure occurred (e.g., a date, a time, and/or a timestamp) and a type of the attempted card read (e.g., chip, magnetic stripe, or contactless device). Furthermore, in cases where the transaction terminal is able to read incomplete or partial information, the card read failure indication may include the incomplete or partial information that was read from the transaction card (e.g., the first several digits of the account number, which may be used to identify the issuer of the transaction card and/or identify cases where the customer subsequently uses a different transaction card, other than the transaction card that failed, to complete the payment, as described in further detail below). Additionally, or alternatively, the card read failure indication may include a total count of card read failures, a count of card read failures within a time period, a time period between card read failures (e.g., to identify multiple card read failures that may be associated with the same transaction card, as a large time period between card read failures may indicate that the card read failures are associated with different transaction cards), and/or a value (e.g., dollar amount) of the transaction associated with the card read failure (e.g., to determine whether future card read attempts and/or card read failures are associated with the same transaction card). Furthermore, in cases where the card read failure is associated with an error code (e.g., a failure to power the chip or another condition that has a known cause and/or potential fix), the card read failure indication may include the error code to provide assistance with troubleshooting the problem that resulted in the card read failure.

In some implementations, the card read failure indication may be associated with a time-to-live (TTL) value or one or more conditions for deleting the card read failure indication. For example, in some implementations, the card read failure indication may be deleted in cases where a successful read is completed within a threshold time after the card read failure (e.g., indicating that the initial failure may be due to user error or an anomalous event). In other examples, the card read failure indication may be maintained and reported to the external device regardless of whether there is a successful read after the card read failure. For example, the successful read may be performed with a different transaction card than the transaction card that was not properly read, or the successful read may be associated with a different read type (e.g., a successful chip read after a failed read using a contactless device or a successful swipe following a failed chip read, among other examples). Accordingly, maintaining and reporting the card read failure indication in cases where there is a successful read after the card read failure may provide relevant context to determining whether the transaction card and/or the transaction terminal is defective (e.g., the card read failure indication may indicate that the transaction card is defective if the transaction terminal is able to perform a successful read with a different transaction card, may indicate that a particular reading mechanism is defective, such as a chip and/or chip reader, if the transaction terminal is able to perform a successful read using a different read type).

As further shown in FIG. 1, and by reference number 140, the transaction terminal may process a successful transaction after the card read failure has occurred. For example, in some implementations, the successful transaction may be a fallback transaction in which the transaction terminal initially fails to read the transaction card using a first read type (e.g., a chip read) and subsequently is able to read the transaction card using a second read type (e.g., reading a magnetic stripe or a contactless device). Additionally, or alternatively, the successful transaction may be a manual entry transaction in which a merchant manually enters information associated with the transaction card after one or more reading mechanisms fail or fail repeatedly (e.g., a threshold number of times). Furthermore, in some implementations, the merchant may enter, into the transaction terminal, information that indicates a reason for manually entering the information associated with the transaction card (e.g., to differentiate a card read failure or a specific type of card read failure from a card-not-present transaction). For example, the reason may indicate that the information associated with the transaction card was manually entered due to a card read failure, or the reason may indicate more details associated with the card read failure (e.g., specific failure type(s), which may include a failed chip read, a failed swipe, and/or a failed tap attempt and/or a number of attempted reads that resulted in the failure, among other examples). In general, when the successful transaction is a fallback transaction or a manual entry transaction using the transaction card that was initially not read, the successful transaction and the card read failure indication may be linked to the same transaction card. In such cases, information associated with the successful transaction may be used to identify the transaction card that the transaction terminal was unable to read, which may be used to report the card read failure indication to the issuer of the transaction card. Alternatively, in some cases, the successful transaction may be performed using a different transaction card. In such cases, the information associated with the successful transaction may be decoupled from the card read failure indication, except to indicate that the consumer had to resort to using a different transaction card due to the card read failure.

As further shown in FIG. 1, and by reference number 150, the transaction terminal may report one or more card read failure indications to one or more external devices. For example, in some implementations, the transaction terminal may check the cache or memory of the transaction terminal for the presence of one or more card read failure indications when a successful transaction is processed (e.g., whether based on manual entry of transaction card information or reading information from the chip, magnetic stripe, or contactless device of the transaction card), and may report, to the external device(s) any card read failure indication(s) that are present in the cache or memory at the time that the successful transaction is processed. For example, as described above, one or more card read failure indications may be associated with a TTL value or other information that indicates when the card read failures expire and are deleted from the cache or memory (e.g., to avoid reporting stale card read failures). Additionally, or alternatively, the transaction terminal may identify card read failure indications with a recent timestamp, in which case the card read failure indication(s) may be reported when a difference between a time when the transaction terminal failed to read the transaction card and a time of the successful transaction satisfies a threshold (e.g., indicating that the card read failure indication is associated with the successful transaction). Additionally, or alternatively, the transaction terminal may identify card read failure indications that are created based on a merchant entering or otherwise inputting information that indicated that the card read failures occurred.

Accordingly, in cases where one or more card read failure indications are identified in the cache or memory, the one or more card read failure indications may be reported to one or more external devices that may be configured to determine whether the card read failure indications are associated with a defective transaction card, a defective transaction terminal, and/or user or operator error, among other examples. In some implementations, the transaction terminal may transmit any card read failure indications (or recent card read failure indications) to the external device(s) when a successful transaction occurs, in batches at periodic intervals, and/or when a quantity of card read failure indications in the cache or memory satisfy a threshold, among other examples. In some implementations, the information that is reported to the external device(s) may include one or more flags to indicate that a card read error occurred, or the reported information may include additional details to identify a defective transaction card, a defective transaction terminal, and/or a user or operator error. For example, in some implementations, the information reported to the external device(s) may include an identifier associated with the transaction terminal or an identifier associated with the merchant operating the POS system (e.g., to detect whether the issue is with the transaction terminal) and/or any suitable combination of the data that is gathered and stored when the card read failure is detected, as described in further detail above. Furthermore, in some implementations, one or more card read failure indications that are stored in the cache or memory may be cleared or otherwise removed from the cache or memory after the one or more card read failure indications are reported to the external device(s).

In some implementations, the external device(s) configured to receive the card read failure indications may be a merchant device that is part of the same POS system as the transaction terminal. In such cases, the merchant device may aggregate card read failure indications from the transaction terminal and any other transaction terminals that may be part of the POS system, and may analyze the card read failure indications to identify potentially defective transaction terminals. For example, if one or more transaction terminals are reporting card read failure indications more frequently than expected (e.g., a proportion or percentage of card read failures satisfies a threshold), the merchant device may generate a notification that the one or more transaction terminals are defective and may need to be repaired or replaced. In some implementations, the transaction terminal may be configured to report the card read failure indication(s) to the merchant device based on determining that one or more conditions are satisfied, where the one or more conditions may indicate that the card read failure is more likely to be an issue with the transaction terminal than the transaction card (e.g., card read failures from a threshold number of different cards at the same transaction terminal).

Additionally, or alternatively, the external device(s) configured to receive the card read failure indications may be a card issuer device that is associated with an issuer of the transaction card that the transaction terminal failed to read. For example, in some implementations, a transaction card may generally include a prefix (e.g., a first six numbers) that is used to identify the issuer of the transaction card. Accordingly, in cases where the transaction terminal is able to determine the prefix of the transaction card (e.g., based on a partial or incomplete read, or manual entry of the transaction card information), the transaction terminal may identify the card issuer device to which to report the card read failure indication based on the prefix of the transaction card. For example, in some implementations, the transaction terminal may communicate with the card issuer device using an application program interface that is separate from transaction data that is communicated to a transaction backend system. In some implementations, the card issuer device may then analyze the card read failure indications that are received from the transaction terminal and the card read failure indications that are reported by other transaction terminals to determine appropriate remedial action, if any, to be taken.

For example, as shown by reference number 160, the card issuer device may transmit a notification to the merchant device to indicate that the transaction terminal may be defective and need to be repaired or replaced (e.g., when a transaction card is associated with a card read failure at the transaction terminal but is subsequently used several times without issue at other transaction terminals and/or when there are a threshold number of card read failures or a threshold proportion of card read failures out of all transactions at the transaction terminal, among other examples). In this way, the card issuer device and/or the merchant device may proactively detect and repair or replace defective transaction terminals.

Additionally, or alternatively, as shown by reference number 170, the card issuer device may issue a new (replacement) card based on determining that the transaction card is defective. For example, the card issuer device may determine that the transaction card is defective based on observing card read failure indications involving the transaction card at different transaction terminals, based on one or more transactions in which the transaction card was swapped for a different transaction card after a failed card read, and/or based on one or more fallback or manual entry transactions involving the transaction card, among other examples. In some implementations, the card issuer device may automatically issue the replacement card, or the replacement card may be issued manually by an operator based on review of the card read failure indications. Additionally, or alternatively, the card issuer device may send an alert to the user of the transaction card to indicate that the transaction card may be defective and/or to provide an option to request a replacement card. Additionally, or alternatively, the card issuer device may determine that a batch of transaction cards are defective (e.g., based on card read failures involving multiple transaction cards that were produced in the same batch) and the card issuer device may automatically or manually issue replacement cards for the entire batch of defective transaction cards. In this way, the card issuer device and/or the merchant device may proactively identify and repair or replace transaction cards and/or card reading equipment that may be defective or malfunctioning.

As indicated above, FIG. 1 is provided as an example. Other examples may differ from what is described with regard to FIG. 1.

FIG. 2 is a diagram of an example environment 200 in which systems and/or methods described herein may be implemented. As shown in FIG. 2, environment 200 may include a transaction terminal 210, a transaction device 220, a mobile device 230, a transaction backend system 240, a card issuer device 250, a merchant device 260, and/or a network 270. Devices of environment 200 may interconnect via wired connections and/or wireless connections.

The transaction terminal 210 includes one or more devices capable of facilitating an electronic transaction associated with the transaction device 220. For example, the transaction terminal 210 may include a POS terminal, a payment terminal (e.g., a credit card terminal, a contactless payment terminal, a mobile credit card reader, or a chip reader), and/or an automated teller machine (ATM). The transaction terminal 210 may include one or more input components and/or one or more output components to facilitate obtaining data (e.g., account information) from the transaction device 220 and/or to facilitate interaction with and/or authorization from an owner or accountholder of the transaction device 220. Example input components of the transaction terminal 210 include a number keypad, a touchscreen, a magnetic stripe reader, a chip reader, and/or a radio frequency (RF) signal reader (e.g., a near-field communication (NFC) reader). Example output devices of transaction terminal 210 include a display and/or a speaker.

The transaction device 220 includes one or more devices capable of being used for an electronic transaction. In some implementations, the transaction device 220 includes a transaction card (or another physical medium with integrated circuitry) capable of storing and communicating account information, such as a credit card, a debit card, a gift card, an ATM card, a transit card, a fare card, and/or an access card. In some implementations, the transaction device 220 may be the mobile device 230 or may be integrated into the mobile device 230. For example, the mobile device 230 may execute an electronic payment application capable of performing functions of the transaction device 220 described herein. Thus, one or more operations described herein as being performed by the transaction device 220 may be performed by a transaction card, the mobile device 230, or a combination thereof.

The transaction device 220 may store account information associated with the transaction device 220, which may be used in connection with an electronic transaction facilitated by the transaction terminal 210. The account information may include, for example, an account identifier that identifies an account (e.g., a bank account or a credit account) associated with the transaction device 220 (e.g., an account number, a card number, a bank routing number, and/or a bank identifier), a cardholder identifier (e.g., identifying a name of a person, business, or entity associated with the account or the transaction device 220), expiration information (e.g., identifying an expiration month and/or an expiration year associated with the transaction device 220), and/or a credential (e.g., a payment token). In some implementations, the transaction device 220 may store the account information in tamper-resistant memory of the transaction device 220, such as in a secure element. As part of performing an electronic transaction, the transaction device 220 may transmit the account information to the transaction terminal 210 using a communication component, such as an integrated circuit (IC) chip (e.g., a EUROPAY®, MASTERCARD®, VISA® (EMV) chip), a magnetic stripe, and/or a contactless communication component (e.g., an NFC component, an RF component, a Bluetooth component, and/or a Bluetooth Low Energy (BLE) component). Thus, the transaction device 220 and the transaction terminal 210 may communicate with one another by coming into contact with one another (e.g., using an EMV chip or a magnetic stripe) or via contactless communication (e.g., using NFC).

The mobile device 230 includes one or more devices capable of being used for an electronic transaction, as described above in connection with the transaction device 220. The mobile device 230 may include a communication device and/or a computing device. For example, the mobile device 230 may include a wireless communication device, a mobile phone, a user equipment, a tablet computer, a wearable communication device (e.g., a smart wristwatch, a pair of smart eyeglasses, a head mounted display, or a virtual reality headset), or a similar type of device.

The transaction backend system 240 includes one or more devices capable of processing, authorizing, and/or facilitating a transaction. For example, the transaction backend system 240 may include one or more servers and/or computing hardware (e.g., in a cloud computing environment or separate from a cloud computing environment) configured to receive and/or store information associated with processing an electronic transaction. The transaction backend system 240 may process a transaction, such as to approve (e.g., permit, authorize, or the like) or decline (e.g., reject, deny, or the like) the transaction and/or to complete the transaction if the transaction is approved. The transaction backend system 240 may process the transaction based on information received from the transaction terminal 210, such as transaction data (e.g., information that identifies a transaction amount, a merchant, a time of a transaction, a location of the transaction, or the like), account information communicated to the transaction terminal 210 by the transaction device 220, and/or information stored by the transaction backend system 240 (e.g., for fraud detection).

The transaction backend system 240 may be associated with a financial institution (e.g., a bank, a lender, a credit card company, or a credit union) and/or may be associated with a transaction card association that authorizes a transaction and/or facilitates a transfer of funds. For example, the transaction backend system 240 may be associated with an issuing bank associated with the transaction device 220, an acquiring bank (or merchant bank) associated with the merchant and/or the transaction terminal 210, and/or a transaction card association (e.g., VISA® or MASTERCARDR®) associated with the transaction device 220. Based on receiving information associated with the transaction device 220 from the transaction terminal 210, one or more devices of the transaction backend system 240 may communicate to authorize a transaction and/or to transfer funds from an account associated with the transaction device 220 to an account of an entity (e.g., a merchant) associated with the transaction terminal 210.

The card issuer device 250 includes one or more devices capable of receiving, generating, storing, processing, and/or providing information associated with a failed card reading to identify a defective transaction card and/or a defective transaction terminal, as described elsewhere herein. The card issuer device 250 may include a communication device and/or a computing device. For example, the card issuer device 250 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The card issuer device 250 may communicate with one or more other devices of environment 200. For example, as described elsewhere herein, the card issuer device 250 may receive one or more card read failure indications from the transaction terminal 210, may transmit one or more messages to the merchant device 260 to indicate that the transaction terminal 210 is defective, and/or may communicate with the mobile device 230 or another device associated with a user of the transaction device 220 to indicate that the transaction device 220 may be defective.

The merchant device 260 includes one or more devices capable of receiving, generating, storing, processing, and/or providing information associated with a failed card reading to identify a defective transaction card and/or a defective transaction terminal, as described elsewhere herein. The merchant device 260 may include a communication device and/or a computing device. For example, the merchant device 260 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The merchant device 260 may communicate with one or more other devices of environment 200, as described elsewhere herein. In some implementations, the merchant device 260 and the transaction terminal 210 may be included in a POS system. For example, the merchant device 260 may include POS equipment, such as a cash register, a smartphone, a tablet, and/or another device connected to the transaction terminal 210. Additionally, or alternatively, the merchant device 260 may be associated with a transaction management system or other suitable system to manage transactions that are performed using the transaction terminal 210.

The network 270 includes one or more wired and/or wireless networks. For example, the network 270 may include a cellular network, a public land mobile network, a local area network, a wide area network, a metropolitan area network, a telephone network, a private network, the Internet, and/or a combination of these or other types of networks. The network 270 enables communication among the devices of environment 200. In some implementations, the transaction terminal 210 may communicate with the transaction device 220 using a first network (e.g., a contactless network or by coming into contact with the transaction device 220) and may communicate with the transaction backend system 240 using a second network.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300, which may correspond to the transaction terminal 210, the transaction device 220, the mobile device 230, the transaction backend system 240, the card issuer device 250, and/or the merchant device 260. In some implementations, the transaction terminal 210, the transaction device 220, the mobile device 230, the transaction backend system 240, the card issuer device 250, and/or the merchant device 260 may include one or more devices 300 and/or one or more components of device 300. As shown in FIG. 3, device 300 may include a bus 310, a processor 320, a memory 330, an input component 340, an output component 350, and a communication component 360.

Bus 310 includes one or more components that enable wired and/or wireless communication among the components of device 300. Bus 310 may couple together two or more components of FIG. 3, such as via operative coupling, communicative coupling, electronic coupling, and/or electric coupling. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform one or more operations or processes described elsewhere herein.

Memory 330 includes volatile and/or nonvolatile memory. For example, memory 330 may include random access memory (RAM), read only memory (ROM), a hard disk drive, and/or another type of memory (e.g., a flash memory, a magnetic memory, and/or an optical memory). Memory 330 may include internal memory (e.g., RAM, ROM, or a hard disk drive) and/or removable memory (e.g., removable via a universal serial bus connection). Memory 330 may be a non-transitory computer-readable medium. Memory 330 stores information, instructions, and/or software (e.g., one or more software applications) related to the operation of device 300. In some implementations, memory 330 includes one or more memories that are coupled to one or more processors (e.g., processor 320), such as via bus 310.

Input component 340 enables device 300 to receive input, such as user input and/or sensed input. For example, input component 340 may include a touch screen, a keyboard, a keypad, a mouse, a button, a microphone, a switch, a sensor, a global positioning system sensor, an accelerometer, a gyroscope, and/or an actuator. Output component 350 enables device 300 to provide output, such as via a display, a speaker, and/or a light-emitting diode. Communication component 360 enables device 300 to communicate with other devices via a wired connection and/or a wireless connection. For example, communication component 360 may include a receiver, a transmitter, a transceiver, a modem, a network interface card, and/or an antenna.

Device 300 may perform one or more operations or processes described herein. For example, a non-transitory computer-readable medium (e.g., memory 330) may store a set of instructions (e.g., one or more instructions or code) for execution by processor 320. Processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, processor 320 may be configured to perform one or more operations or processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

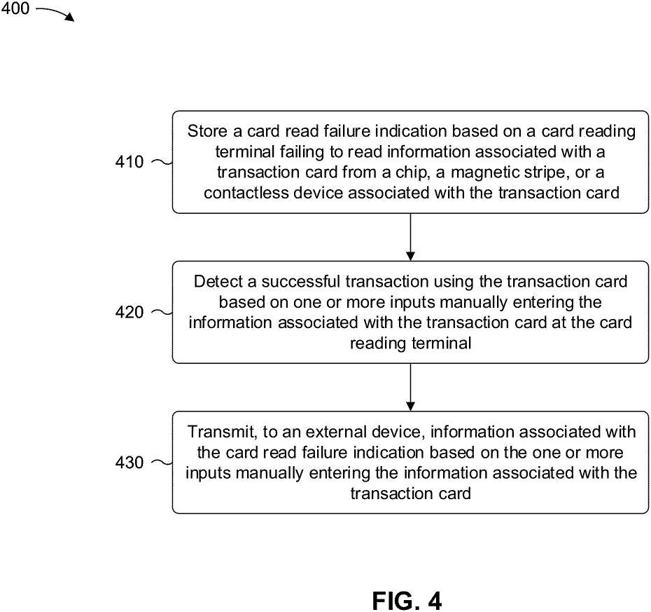

FIG. 4 is a flowchart of an example process 400 associated with indicating a failed card reading to identify a defective transaction card and/or a defective transaction terminal. In some implementations, one or more process blocks of FIG. 4 may be performed by a POS system (e.g., transaction terminal 210 and/or merchant device 260). In some implementations, one or more process blocks of FIG. 4 may be performed by another device or a group of devices separate from or including the POS system, such as transaction device 220, mobile device 230, transaction backend system 240, and/or card issuer device 250. Additionally, or alternatively, one or more process blocks of FIG. 4 may be performed by one or more components of device 300, such as processor 320, memory 330, input component 340, output component 350, and/or communication component 360.

As shown in FIG. 4, process 400 may include storing a card read failure indication based on a transaction terminal failing to read information associated with a transaction card from a chip, a magnetic stripe, or a contactless device associated with the transaction card (block 410). As further shown in FIG. 4, process 400 may include detecting a successful transaction using the transaction card based on one or more inputs manually entering the information associated with the transaction card at the transaction terminal (block 420). As further shown in FIG. 4, process 400 may include transmitting, to an external device, information associated with the card read failure indication based on the one or more inputs manually entering the information associated with the transaction card (block 430). In some implementations, the information associated with the card read failure indication is transmitted to enable the external device to determine whether one or more of the transaction card or the transaction terminal is defective.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term "component" is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to "at least one of" a list of items refers to any combination of those items, including single members. As an example, "at least one of: a, b, or c" is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles "a" and "an" are intended to include one or more items, and may be used interchangeably with "one or more." Further, as used herein, the article "the" is intended to include one or more items referenced in connection with the article "the" and may be used interchangeably with "the one or more." Furthermore, as used herein, the term "set" is intended to include one or more items (e.g., related items, unrelated items, or a combination of related and unrelated items), and may be used interchangeably with "one or more." Where only one item is intended, the phrase "only one" or similar language is used. Also, as used herein, the terms "has," "have," "having," or the like are intended to be open-ended terms. Further, the phrase "based on" is intended to mean "based, at least in part, on" unless explicitly stated otherwise. Also, as used herein, the term "or" is intended to be inclusive when used in a series and may be used interchangeably with "and/or," unless explicitly stated otherwise (e.g., if used in combination with "either" or "only one of").

1. A system for indicating failed card readings to identify defective transaction cards or defective transaction terminals, the system comprising:
one or more memories; and
one or more processors, coupled to the one or more memories, configured to:
store, in the one or more memories, a card read failure indication and a card read failure deletion indication based on a transaction terminal failing to read information associated with a transaction card from a chip, a magnetic stripe, or a contactless device associated with the transaction card ;
detect a successful transaction based on the transaction terminal successfully reading the information associated with the transaction card based on one or more inputs manually entering the information associated with the transaction card at the transaction terminal;
determine, based on the successful transaction being completed within a time-to-live (TTL) value associated with a deletion of the card read failure deletion indication from the one or more memories, to transmit information associated with the card read failure indication; and
transmit, to an external device, the information associated with the card read failure indication based on determining to transmit the information
wherein the information associated with the card read failure indication is transmitted to enable the external device to determine whether one or more of the transaction card or the transaction terminal is defective.

2. The system of claim 1, wherein the card read failure indication includes information related to a first time when the transaction terminal failed to read the information associated with the transaction card, and wherein the information associated with the card read failure indication is transmitted to the external device based on a difference between the first time and a second time associated with the successful transaction satisfying a threshold.

3. The system of claim 1, wherein the one or more processors are configured to detect that the transaction terminal failed to read the information associated with the transaction card based on or more of a failure to detect or read the chip associated with the transaction card, a partial read or incomplete read of the magnetic stripe, or a threshold quantity of tap attempts using the contactless device with partial or incomplete information.

4. The system of claim 1, wherein one or more of the card read failure indication or the information transmitted to the external device indicates whether the transaction terminal failed to read the information associated with the transaction card from the chip, the magnetic stripe, or the contactless device associated with the transaction card.

5. The system of claim 1, wherein the external device is associated with an issuer of the transaction card, and wherein the one or more processors are further configured to:
identify the issuer of the transaction card based on a transaction card prefix provided in the one or more inputs manually entering the information associated with the transaction card.

6. The system of claim 1, wherein the one or more processors are further configured to:
receive, from the external device, a message indicating that the transaction terminal is defective based on the transaction terminal being associated with card read failure indications from multiple different transaction cards.

7. The system of claim 1, wherein the card read failure indication includes an error code that indicates a reason for the transaction terminal failing to read the information associated with the transaction card.

8. The system of claim 1, wherein the information transmitted to the external device includes an identifier associated with the transaction terminal that failed to read the information associated with the transaction card.

9. A method for detecting and indicating failed card readings, comprising:
detecting, by a point-of-sale (POS) system, that a transaction terminal failed to read information associated with a transaction card,
storing, by the POS system and in a memory of the POS system, a card read failure indication and a card read failure deletion indication based on the transaction terminal failing to read the information associated with the transaction card,
wherein the card read failure deletion indication includes information that indicates whether the transaction terminal failed to read the information associated with the transaction card from a chip, a magnetic stripe, or a contactless device ; and
transmitting, by the POS system, information associated with the card read failure indication to an external device based on:
detecting a successful transaction subsequent to the transaction terminal failing to read the information associated with the transaction card, and
the successful transaction being completed within a time-to-live (TTL) value associated with a deletion of the card read failure deletion indication from the memory of the POS system,
wherein the information associated with the card read failure indication is transmitted to enable the external device to determine whether one or more of the transaction card or the transaction terminal is defective.

10. The method of claim 9, wherein the information transmitted to the external device indicates that a transaction card used in the successful transaction differs from the transaction card that the transaction terminal failed to read based on the card read failure indication including partial or incomplete information that differs from information associated with the transaction card used in the successful transaction.

11. The method of claim 9, wherein one or more of the card read failure indication or the information transmitted to the external device indicates whether the transaction terminal failed to read the information associated with the transaction card from the chip, the magnetic stripe, or the contactless device associated with the transaction card.

12. The method of claim 9, further comprising:
identifying an issuer of the transaction card based on a transaction card prefix provided in one or more inputs manually entering the information associated with the transaction card, wherein the information associated with the card read failure indication is transmitted to the external device using an application program interface associated with the issuer of the transaction card.

13. The method of claim 9, further comprising:
receiving, from the external device, a message indicating that the transaction terminal is defective based on the transaction terminal being associated with card read failure indications from multiple different transaction cards.

14. The method of claim 9, wherein the card read failure indication includes an error code that indicates a reason for the transaction terminal failing to read the information associated with the transaction card.

15. The method of claim 9, wherein the information transmitted to the external device includes an identifier associated with the transaction terminal that failed to read the information associated with the transaction card.

16. A non-transitory computer-readable medium storing a set of instructions, the set of instructions comprising:
one or more instructions that, when executed by one or more processors of a system, cause the system to:
store, in a memory of the system, a card read failure indication and a card read failure deletion indication based on a transaction terminal failing to read information associated with a transaction card ;
detect a successful transaction using the transaction card; and
transmit, to an external device, information associated with the card read failure indication based on:
the successful transaction using the transaction card, and the successful transaction being completed within a time-to-live (TTL) value associated with a deletion of the card read failure deletion indication from the memory of the system,
wherein the information associated with the card read failure indication is transmitted to enable the external device to determine whether one or more of the transaction card or the transaction terminal is defective.

17. The non-transitory computer-readable medium of claim 16, wherein the one or more instructions further cause the system to detect that the transaction terminal failed to read the information associated with the transaction card based on or more of a failure to detect or read a chip associated with the transaction card, a partial read or incomplete read of a magnetic stripe associated with the transaction card, or a threshold quantity of tap attempts using a contactless device associated with the transaction card.

18. The non-transitory computer-readable medium of claim 16, wherein one or more of the card read failure indication or the information transmitted to the external device indicates whether the transaction terminal failed to read the information associated with the transaction card from a chip, a magnetic stripe, or a contactless device associated with the transaction card.

19. The non-transitory computer-readable medium of claim 16, wherein the one or more instructions further cause the system to:
receive, from the external device, a message indicating that the transaction terminal is defective based on the transaction terminal being associated with card read failure indications from multiple different transaction cards.

20. The non-transitory computer-readable medium of claim 16, wherein the information transmitted to the external device includes an identifier associated with the transaction terminal that failed to read the information associated with the transaction card.
